(19) United States
(12) Patent Application Publication
(10) Pub. No.: US 2008/0081145 A1
(43) Pub. Date: Apr. 3, 2008

(54) Heat shield

(76) Inventor: Franz Schweiggart, Pfaffenhofen (DE)

Correspondence Address: MARSHALL & MELHORN, LLC, FOUR SEAGATE, 8TH FLOOR, TOLEDO, OH, 43804, US

(21) Appl. No.: 11/904,138

(22) Filed: Sep. 26, 2007

(30) Foreign Application Priority Data
Sep. 27, 2006 (EP) EP 06020254.6

(51) Int. Cl. B32B 1/04

(52) U.S. Cl. 428/68

(57) ABSTRACT

A heat shield for shielding an object from heat and/or noise having an internal surface facing toward the object and an external surface facing away from the object as well as an opening which goes through the heat shield having internal surface and external surface. The heat shield has a closure for at least regionally closing the opening, which opens and closes automatically as a function of the temperature.

### RELATED APPLICATIONS

The present application claims priority from EP 06020254.6 filed on Sep. 27, 2006, which is incorporated by reference in its entirety.

### FIELD OF THE INVENTION

The present invention relates to a heat shield for shielding an object against heat and/or noise having an internal surface facing toward the object and an external surface facing away from the object as well as at least one opening, which goes through the heat shield having internal and external surfaces.

### BACKGROUND OF THE INVENTION

Heat shields of this type are used, for example, in engine compartments of motor vehicles, in particular in the area of the exhaust system, to protect neighboring temperature-sensitive components and assemblies from impermissible heating. The heat shields are often used simultaneously as a noise protector. Concretely, such heat shields may be used, for example, for shielding a catalytic converter or pre-catalytic converter, a particulate filter, or other components in the area of the exhaust system or of a turbocharger. In regard to continuous operation, it is often not only important for these components to be protected from too strong a temperature strain, but rather the operating temperature is to be subjected to strong oscillations during the entire operating life as little as possible.

The most possible constant operating temperature is advantageous, for example, for the components used for exhaust treatment, because in this way a more uniform exhaust treatment effect may be achieved. Simultaneously, the service life of the components, neighboring housing parts, and gas-conducting components may also be lengthened. Rapid heating and keeping the operating temperature constant are of special significance in regard to maintaining the future EU exhaust gas standard Euro 5. In addition to the exhaust gas limiting values in the normal operating phase of an engine, exhaust gas limiting values of the cold starting phase are also incorporated here. The efficiency of the exhaust treatment catalytic converters for the pollutants contained in the exhaust gas is known to differ as a function of the temperature. Thus, for example, the discharge of hydrocarbons and carbon monoxide is particularly high at the beginning of the cold start phase. This is primarily to be attributed to the fact that the catalytic converter has not yet reached its operating temperature. To reduce these pollutants, it is therefore necessary to increase the operating temperature of the catalytic converter as rapidly as possible. On the other hand, the operating temperature cannot rise too much, however, because this results on the one hand in the increase of other pollutants such as nitrogen oxides in the exhaust gas, and on the other hand, too high a temperature may damage the catalytic converter itself and neighboring components.

In other cases, it may be desirable, for example, to be able to set a higher or lower temperature during a specific operating phase than in other operating phases. Thus, for example, a particulate filter may pass through an operating phase of higher temperature in which accumulated particles in the particulate filter are removed by oxidation. Up to this point, reaching this elevated temperature by engine measures or by additional injection of fuels was typical. After completed particle removal, the measures were returned to normal operation again. However, this procedure is very complex and requires additional energy.

In consideration of the problems described above, it is the object of the present invention to specify a heat shield which is capable of setting the operating temperature of an object shielded thereby to a predefined range. The heat shield is on the one hand to allow the temperature to be kept as constant as possible and simultaneously ensure the most rapid possible achievement of the operating temperature. On the other hand, the heat shield is also to allow selective operation at various predefined temperatures.

This object is achieved by the heat shield according to Claim 1. Preferred embodiments are specified in the subclaims.

### SUMMARY OF THE INVENTION

The heat shield according to the present invention for shielding an object against heat and/or noise has an internal surface facing toward the object and an external surface facing away from the object. An opening is provided in the heat shield, which goes through the internal and external surfaces. According to the present invention, this opening is at least partly closable by a closure, which opens and closes automatically as a function of the temperature. The opening implemented in the heat shield is exposed by opening the closure, so that better temperature regulation is made possible by the passage thus resulting. For example, hot air accumulated between the object to be shielded, which is situated neighboring the internal surface of the heat shield, and the heat shield may escape through the exposed opening and thus the temperature in the area around the object to be shielded may be reduced. Vice versa, it is just as possible, for example, to introduce colder air in the direction toward the object to be shielded through the exposed opening and thus reduce the temperature in its environment. It is also possible to feed hot air in the direction toward the object to be shielded through the opened opening or discharge cold air if its temperature increase is desired. In addition, the opening may be at least partially closed in an operating phase of increased temperature, while it is at least partially exposed in an operating phase of lower temperature, so that accumulated heat may escape through the opening. More than two operating phases of different temperatures are also fundamentally settable as a function of the opening size of the opening.

A preferred application of the heat shield according to the present invention is, as already noted, the shielding of components in the area of an internal combustion engine and in particular in the area of the exhaust system. In these applications, the danger primarily exists that the object to be shielded will overheat as a result of the accumulated heat in the area of the heat shield. To prevent this, the heat shield according to the present invention is expediently implemented in such a way that the closure is opened if a specific limiting temperature is exceeded, so that the accumulated heat may escape from the area between heat shield and object to be shielded. As long as the components situated in the area of the heat shield have not yet reached their operating temperature, however, the accumulation of heat in the area of the heat shield is completely advisable, so that the components may reach their optimal operating temperature as rapidly as possible. For this reason, the heat shield according to the present invention is preferably designed in this variant in such a way that the closure remains closed until reaching the limiting temperature.

A further preferred application is the shielding of particulate filters, in particular diesel particulate filters. As described, it may be expedient here to remove the accumulated particles by oxidation at increased temperature in a specific operating phase. Using the heat shield according to the present invention, the required temperature increase may be achieved especially easily and rapidly. In contrast to the prior art, it is frequently no longer necessary to increase the exhaust gas temperature by additional engine measures, although this still remains possible. Rather, the opening in the heat shield may be closed by closing the closure. The temperature then rises in the area of the heat shield and thus also in the particulate filter. If this temperature increase alone is insufficient to begin the oxidative cleaning, in addition, the fuel mixture of the engine may be adapted or fuel may be injected directly, as usual. After completed cleaning, the closure is opened again, the additional altered injection is ended if necessary, and the temperature in the area of the heat shield falls again, so that the particulate filter may operate further in the regular operating state.

In the case of the heat shield for a particulate filter or a similar device, the closure is expediently opened at lower temperature and closed at increased temperature. This is preferably reversed for the heat shield described for a catalytic converter. The closure is closed with sinking temperature here, while it is opened in the event of temperature increase. Both variants may be implemented corresponding to the requirements in the scope of the present invention. They may also be used jointly in the same heat shield.

It is not absolutely necessary for the closure to open suddenly if the predefined limiting value is exceeded, for example, and expose the opening 100%, while the closure is immediately completely closed and completely covers the opening at a value of less than or equal to the limiting value. Rather, it is also possible that the opening and closing of the closure occurs within a predefined limiting measured value interval. For example, it may be advisable for the closure to increasingly expose the opening with increasing deviation from the predefined limiting value, so that, for example, with increasing temperature, an increasing temperature exchange with the environment is possible. Vice versa, the opened closure may be increasingly closed again if the increased temperature falls in the direction toward the limiting value again. In this way, a continuous temperature control adapted to the ambient temperature is possible, which allows the object to be shielded by the heat shield to be kept at an essentially constant operating temperature which is optimal for this object. Closing the opening does not have to result in a hermetic seal of the opening. A significantly reduced temperature exchange in relation to the opened state is generally sufficient. The above statements also apply for the case of opening upon sinking temperature and closing upon higher temperature.

The range in which the limiting measured value is set, in which the closure in the heat shield according to the present invention opens or closes, is mainly a function of the temperature at which the object which is to be shielded using the heat shield according to the present invention is to be kept. In the case of catalytic converters, this is expediently the temperature at which the best exhaust gas reduction is possible. For particulate filters, on the one hand the optimal temperature for particle filtration and on the other hand the best temperature for oxidative removal of the particles in the particle removal phase may be set. This particular optimal operating temperature may be achieved very rapidly using the heat shield according to the present invention, because heat may be accumulated in the area around the object to be shielded in the warm-up phase by closing the opening using the closure, so that the object heats rapidly. On the other hand, exceeding an optimal operating temperature too strongly may be prevented by setting the limiting measured value appropriately, upon exceeding of which the closure in the heat shield is opened and thus exposes the opening entirely or partially depending on the measured value. Heat accumulated between heat shield and object to be shielded may escape through the exposed opening. Additionally or alternatively, it is possible to inject cool air through the opened opening in the direction toward the object to be shielded (such as the catalytic converter, particulate filter, etc.), to cool it.

The opening may either be a through opening in the heat shield or also an opening in an external edge area of the heat shield. Both variants may also be combined with one another in one heat shield. The possibility which is selected is also a function, inter alia, of the available space on the heat shield. The shape of the opening is fundamentally arbitrary and is also primarily a function of the available space. The size of the opening is selected as a function of the required heat exchange and/or in regard to the desired noise insulation. The required opening cross-section may be implemented using one or more openings.

The closure may fundamentally have any arbitrary shape which is capable of closing the opening in the heat shield to the required extent. It may be inserted fitting into the opening or may be situated on the heat shield covering the opening. The way in which the closure exposes the opening is also fundamentally arbitrary. For example, the closure may be displaced laterally in relation to the opening and/or pivoted and/or lifted like a flap off the opening. In the two first cases, the closure is preferably displaced and/or pivoted predominantly parallel to the external surface of the heat shield using a slide. In the latter case, the closure may fundamentally open toward any side of the heat shield. However, for space reasons it is frequently expedient for the closure to open toward the side of the external surface of the heat shield, because there is frequently insufficient space on the side of the internal surface between heat shield and object to be shielded.

The closure in the heat shield according to the present invention is implemented in such a way that it automatically opens and closes as a function of the temperature. To ensure optimal temperature conditions for the object to be shielded, it is preferable to implement the closure in such a way that it opens or closes as a function of the temperature on the side of the internal surface of the heat shield. This is expediently implemented in such a way that the closure is moved in relation to the opening by the action of a material which changes its shape under the influence of the temperature. This deformable material may either be a component of the closure itself or a separate part. For example, a bar, a rod, or a similar element is conceivable, which expands and pushes the closure away from the opening in the event of increasing temperature. If the bar contracts again at lower temperature, the closure closes again under the effect of gravity or using a spring element or the like. Alternatively, the temperature of the internal surface of the heat shield may also be relayed inside the closure in such a way that a part of the closure distal from the opening changes its shape under the effect of the temperature and thus causes opening of the closure.

A closure which at least partially comprises a bimetallic element is preferred. A bimetallic element is known to comprise two metallic layers lying one on top of another, one of which has a greater thermal expansion capability than the other. With increasing temperature, the metal having the higher thermal expansion coefficient thus expands more strongly than the metal layer having the lower thermal expansion coefficient. With increasing temperature, the bimetallic element therefore curves toward the direction of the side of the metal layer having the lower thermal expansion coefficient. A closure in the heat shield according to the present invention may be implemented in such a way, for example, that it comprises a bimetallic element like a flap, which is essentially planar in a temperature range below the limiting temperature and closes the opening. Upon reaching the limiting temperature, the layer made of the metal having a higher thermal expansion coefficient increasingly expands and deforms the closure away from the opening and from a surface of the heat shield and thus increasingly exposes the opening. Vice versa, the metal layer having a higher thermal expansion coefficient contracts again with sinking temperature until the bimetallic element is planar again and the opening in heat shield is closed again. This procedure is repeatable practically arbitrarily often at high reproducibility. The closure may simultaneously be produced in a very simple and cost-effective way and integrated in the heat shield according to the present invention without further measures. Moreover, practically any arbitrary limiting temperature or any arbitrary limiting temperature interval is settable easily over a wide range by suitable material selection.

Vice versa, the bimetallic element may also be situated in such a way that it deforms in the direction toward the heat shield with rising temperature, so that the opening is closed above a limiting temperature.

The flap-like closure comprising a bimetallic element does not have to be completely formed by a bimetal. Rather, it suffices if only a partial area of the closure is formed by a bimetallic element. This bimetallic element is expediently either situated in the area of the flap-like closure which is connected to the heat shield, or at least in proximity to the area at which the flap-like closure is fastened to the heat shield. In contrast, the free end of the flap-like closure may comprise a material which is not a bimetal and is only retained on a section made of a bimetal.

For a flap-like closure which is to keep the opening closed up to a limiting temperature, the bimetallic element is expediently situated in relation to the heat shield in such a way that the side facing toward the internal surface of the heat shield comprises the material having a higher thermal expansion coefficient, in contrast, the side facing toward the external surface is made of the material having a lower thermal expansion coefficient. In this case, the flap-like closure thus opens toward the side of the external surface of the heat shield.

In an alternative embodiment, the closure is implemented in such a way that the heat shield has a displaceable plate which is guided by a slide at least partially comprising bimetal and covers the opening of the heat shield in the non-deformed state of the bimetal. It is preferable if at least a part of the slide made of the bimetal is part of the internal surface of the heat shield. If the temperature on the inside of the heat shield rises above a limiting temperature, the slide begins to deform and displaces the plate in such a way that it exposes at least a part of the opening. The opening also closes again in this embodiment when the slide contracts upon cooling and guides the plate onto the opening again under the effect of gravity or using a spring element or the like.

A configuration made of a plate having a slide at least partially comprising bimetal may either be constructed on a thrust or a pull mechanism. In the pull mechanism, the bimetallic element is situated in such a way that the side facing toward the plate or opening in the heat shield comprises the material having a higher thermal expansion coefficient, in contrast, the side facing away from the plate or the opening in the heat shield comprises the material having a lower thermal expansion coefficient. The configuration is reversed for a thrust mechanism.

In a variant of this embodiment, the slide at least partially made of bimetal is not part of the internal surface of the heat shield, but rather the heat transfer occurs via another part of the closure. The slide again guides the plate in such a way that it at least partially exposes the opening if the temperature increases above the limiting temperature and closes the opening again if the temperature drops below the limiting temperature. In the event of greater distance of the bimetal from the heat shield, the opening only begins significantly above the limiting temperature and the closing only begins significantly below the limiting temperature, because the effect of heat does not occur immediately. This effect may be attenuated by the use of an especially sensitive bimetal. On the other hand, external temperature influences, such as the temperature existing in the engine compartment, may also influence the controller due to this configuration.

All embodiments described having a bimetallic closure may also be implemented in such a way that the closure closes up on exceeding a limiting temperature. This may be achieved, for example, in that the bimetallic element is bent away from the opening in the temperature range below the limiting temperature and the layer oriented on the side facing away from the opening, having a higher thermal expansion coefficient, expands in the direction toward the opening upon reaching the limiting temperature. The bimetallic element stretches and thus evens out over the opening with increasing temperature.

In a further variant, the closure plate is connected rotatably at a point to the heat shield lying underneath, e.g., using a flat screw connection. Here as well, a slide at least partially comprising bimetal may cause opening and closing as a function of the temperature. One end of the slide is guided so it is displaceable in principle on one side of the plate. Upon curvature of the part of the slide comprising bimetal, this end of the slide travels along the side of the closure plate and causes opening or closing of the opening by a rotational movement of the plate around the fastening point between plate and heat shield.

Especially good regulation of the temperature in the area between heat shield and object to be shielded is possible if, in addition to the first opening having the first closure, at least one further opening is provided, which is also closable using a closure opening and closing automatically as a function of the temperature. The further closure may be implemented fundamentally as described above. The presence of at least one further closure and an opening closable thereby has the advantage that the temperature in the area between heat shield and object to be shielded may be set even more precisely. For example, it is possible to implement the closures in such a way that they open in sequence if various limiting temperatures are exceeded. This may be achieved, for example, by using different bimetallic elements in/on the closures. The opening of the closures in sequence may be performed in such a way, for example, that the exposed total opening cross-section of the opening rises with increasing temperature, so that increasingly more hot air may escape through the exposed opening. Overheating may thus be prevented even in the event of very strongly rising temperatures.

A further advantage which may be achieved by providing multiple openings closable using a closure is that targeted flow guiding is possible in the space between heat shield and object to be shielded. For example, cooler air may be introduced in the direction toward the object through one or more of the exposed openings if the closure is opened, while heated air flows out through the remaining openings. The openings and closures on the heat shield are expediently oriented in such a way that the hot air flowing out is not directed toward temperature-sensitive parts situated in the surroundings of the heat shield. Ideally, the hot exhaust air is directed in such a way that it is fed to an external flow existing in the area around the heat shield and is conveyed thereby. It is also advantageous if the cooler air introduced into the area between heat shield and object to be heated is fed from this external flow existing in the area around the heat shield.

As already described above, it is also possible in the case of feeding cooler air into the area between heat shield and object to be shielded that various closures open for the feeding of cooler air at different temperatures. This is also fundamentally true for the closures through which the heated air flows out. In this way, a very constant temperature may be ensured in the area between heat shield and object to be shielded over a large temperature range. Additionally or alternatively to these measures, it is also possible that the closures for feeding cooler air open at a different temperature than the closures for exhausting heated air. In the latter case, it is preferable for the feed closures to open at a somewhat higher temperature than the closures for exhausting hot air.

The heat shield according to the present invention is not restricted to special shapes or sizes. For example, it may be a planar heat shield, which is attached above the object to be shielded, so that hot air accumulates below the heat shield. The present invention is especially suitable for a heat shield which essentially encloses the object to be shielded on all sides. A comparable effect may also be achieved if a heat shield open on one side is closed by an adjoining component. The object to be shielded is thus largely encapsulated by the heat shield and possibly other components. This typically does not represent a hermetic enclosure, because hermetically terminated passages for supply lines and drain lines are typically not provided in the heat shield. Nonetheless, the heat exchange with the environment is relatively restricted in these cases, so that overheating of the components encapsulated in the heat shield may occur very rapidly. On the other hand, the cold start phase is relatively short, because the desired operating temperature is achieved rapidly by the heat retention inside the heat shield. This optimal operating temperature may be kept constant in a desired range easily using the heat shield configuration according to the present invention by the provision according to the present invention of at least one opening which is closable by a flap opening and closing as a function of a measured variable. The at least one heat shield, which essentially completely encloses the object to be shielded, additionally ensures especially good noise insulation.

The measures suggested according to the present invention may be implemented easily and cost-effectively without additional complicated measures or components in typical heat shields. The main bodies of the heat shield according to the present invention may thus fundamentally correspond in their implementation to those which are already known from the prior art. Size, shaping, and materials thus correspond to the prior art. Heat shields in sandwich construction, which comprise two outer layers typically made of metallic material and an insulating layer embedded between them, are preferred. The surfaces may be smooth, textured, or perforated. Heat shields of this type are described, for example, in DE 3834054 A1 and EP 1775437 A1 (European Patent Application 05022095.3) of the applicant. Furthermore, reference may be made to GB 2270555 A and US 2004/0142152 A1.

The present invention may fundamentally be applied to all heat shields of the prior art. The present invention is especially suitable for those heat shields which are used in the area of high temperature development and for shielding those objects which may be damaged by excess temperature. A preferred use of the heat shields according to the present invention is therefore in the area of internal combustion engines and particularly in the area of the exhaust system here. Examples of preferred heat shields are those for catalytic converters, pre-catalytic converters, diesel particulate filters, or also turbochargers. The present invention may additionally be applied in particular to metallic subfloors or their components in the area of an exhaust system.

The present invention is explained in greater detail in the following on the basis of drawings. These drawings are exclusively used to illustrate preferred exemplary embodiments of the present invention, without the present invention being restricted thereto. Identical parts are provided with identical reference numerals in the drawings.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1(a): schematically shows a cross-section through a first exemplary embodiment of a heat shield according to the present invention for shielding a catalytic converter having closed closure;

FIG. 1(b): schematically shows the heat shield from FIG. 1(a) having opened closure;

FIG. 2(a): schematically shows a cross-section through a second exemplary embodiment of a heat shield according to the present invention for shielding a catalytic converter having two closed closures;

FIG. 2(b): schematically shows the heat shield from FIG. 2(a) having one open and one closed closure;

FIG. 2(c): schematically shows the heat shield from FIG. 2(a) having two open closures;

FIG. 3(a): schematically shows a cross-section through a third exemplary embodiment of a heat shield according to the present invention for shielding a catalytic converter having one closed closure, the heat shield being open on one side;

FIG. 3(b): schematically shows the heat shield from FIG. 3(a) having open closure;

FIG. 4: schematically shows a partial section through a heat shield according to the present invention in the area of a closure;

FIG. 5: schematically shows a partial section through a further exemplary embodiment of the heat shield according to the present invention in the area of a closure;

FIG. 6(a): schematically shows a cross-section through a fourth exemplary embodiment of a heat shield according to the present invention and a catalytic converter thus shielded having closed closure in the heat shield;

FIG. 6(b): schematically shows the heat shield from FIG. 6(a) having opened closure;

FIG. 7(a): schematically shows a cross-section through a fifth exemplary embodiment of the heat shield according to the present invention and a catalytic converter thus shielded having closed closure in the heat shield;

FIG. 7(b): schematically shows the heat shield from FIG. 7(a) having opened closure;

FIG. 8(a) through 10(c): schematically show detail views of various embodiments of a slide of the heat shield according to the present invention each having closed and opened closure.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

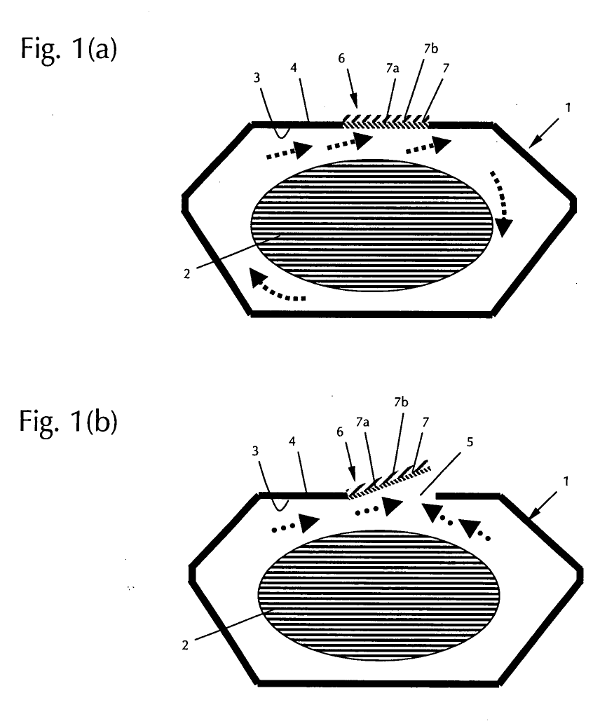

FIGS. 1(a) and 1(b) show a first exemplary embodiment of a heat shield 1 according to the present invention, which is used for shielding a catalytic converter 2 situated in the interior of the heat shield 1. The catalytic converter 2 may be, for example, a catalytic converter for treating exhaust gases of an internal combustion engine of a motor vehicle. The exhaust treatment action of the catalytic converter 2 is best within a specific temperature range. This temperature range is to be reached as rapidly as possible, but is not to be exceeded. The catalytic converter 2 is enclosed essentially completely and on all sides by the heat shield 1. In this way, the catalytic converter 2 and its environment are insulated especially well from one another in regard to temperature influences and noise. In addition, the encapsulation is used so that the catalytic converter 2 reaches the operating temperature required for optimal exhaust treatment rapidly. The cold start phase may thus be shortened by rapid temperature increase in the interior of the heat shield 1, which is a significant advantage in regard to the expected exhaust gas standard Euro 5.

FIG. 1(a) shows the heat shield 1 having the catalytic converter situated in its interior during the warm-up phase to the optimal operating temperature of the catalytic converter 2. In this phase, the closure 6, which is located on the top side of the heat shield and encloses an opening present there in the form of a through opening in the heat shield, is completely closed. The heat generated during operation of the internal combustion engine therefore remains in the interior of the heat shield 1 and heats the catalytic converter rapidly to the desired operating temperature.

The closure 6 completely comprises a bimetallic element 7 in the case shown, which has a two-layered construction made of a metal layer 7a facing toward the internal surface 3 of the heat shield and a metal layer 7b facing toward the external surface 4. The metal layers 7a and 7b are made of materials having different thermal expansion coefficients. The thermal expansion coefficient of the layer 7a is greater than that of the metal layer 7b. The metallic materials and the layer construction are selected in such a way that the metal layer 7a begins to deform and expand above a specific limiting temperature. The deformation of the metal layer 7a results in it bending in the direction toward the external surface 4 of the heat shield 1. The free end of the bimetallic element 7 (on the right side in the figures) thus lifts outward away from the heat shield 1. With rising temperature in the interior of the heat shield 1 and correspondingly increasing deformation of the bimetallic element 7, the closure 6 exposes an increasingly larger opening cross-section of the through opening 5. This is shown in FIG. 1(b). The opening of the closure 6 and the exposure of the through opening 5 upon exceeding the predefined limiting temperature ensure that heat accumulated in the interior of the heat shield 1 may escape through the through opening, as illustrated by the arrows. Overheating of the catalytic converter 2 in the interior of the heat shield 1 is thus avoided. If the temperature in the interior of the heat shield 1 sinks again, the bimetallic element 7 deforms back in the direction toward the starting situation shown in FIG. 1(a). The through opening 5 is closed by the closure 6 again. In this way, too strong sinking of the temperature in the interior of the heat shield 1 is prevented. Another cold start of the engine would again occur with closed closure 6, so that the catalytic converter 2 in the interior of the heat shield 1 may again be brought rapidly to the required operating temperature. These procedures are repeatable arbitrarily often with good reproducibility, so that optimal operating conditions of the catalytic converter may be ensured with very good noise protection simultaneously.

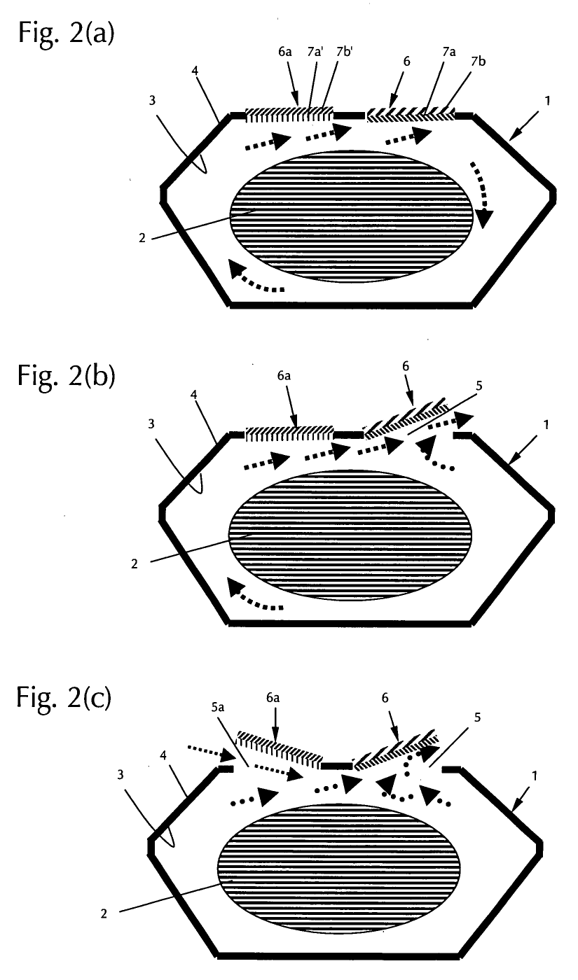

FIGS. 2(a) through 2(c) show a refinement of the heat shield from FIGS. 1(a) and 1(b). In addition to the first closure 6, a further closure 6a is provided in the heat shield 1, which may close a further through opening 5a in the top area of the heat shield 1. The functional principle of both closures corresponds to that of the preceding exemplary embodiment. For simplification, the measuring device 8 is no longer shown.

FIG. 2(a) shows the state of the heat shield 1 in the warm-up phase. Both closures 6 and 6a are closed, so that the heat remains in the interior of the heat shield 1 and contributes to rapidly reaching the operating temperature of the catalytic converter 2. Above a first limiting temperature, which may result in overheating of the catalytic converter 2 especially in full load operation, the first closure 6 is opened in the way described above and exposes the through opening 5 on the top right side of the heat shield 1, so that the hot air indicated by the arrows may escape from the interior of the heat shield 1. The second closure 6a is still closed in this phase. It is first opened upon further temperature increase in the interior of the heat shield 1. This is shown in FIG. 2(c). Cooler air may enter through this through opening into the interior of the heat shield 1 due to the exposure of the through opening 5a. The colder air flows along the top side of the catalytic converter 2, cools it, and entrains hot air through the through opening 5 on the top right side of the heat shield out of its interior. In this way, effective cooling of the catalytic converter is possible even at very high exhaust gas temperature. The exemplary embodiment described thus allows the catalytic converter to operate under essentially constant temperature conditions even in the event of relatively strongly oscillating exhaust gas temperature.

To achieve the opening of the closures 6 and 6a at different limiting temperatures, both closures comprise differently constructed bimetallic elements. The material combination of the layers 7a and 7b thus differs from that of the layers 7a′ and 7b′.

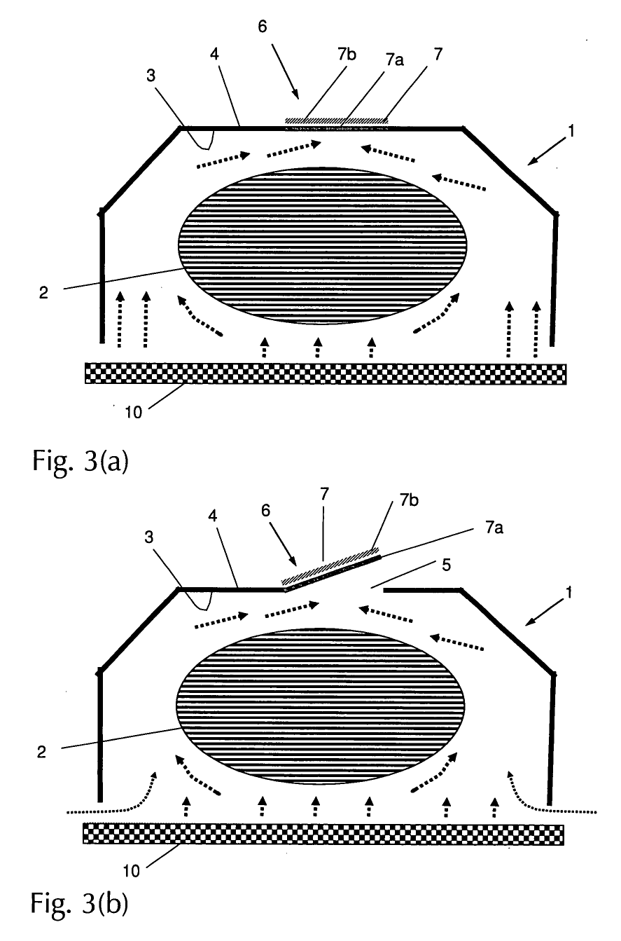

FIGS. 3(a) and 3(b) show an alternative heat shield 1, which does not completely enclose the catalytic converter 2, but rather is open on its bottom side. The lower edge only has a small distance to the neighboring component 10, which radiates heat in operation of the engine. As in the exemplary embodiment from FIGS. 1(a) through 1(c), the heat shield only has one closure 6. The small distance between heat shield 1 and neighboring component 10 accelerates the achievement of the operating temperature of the catalytic converter 2 with closed closure 6. Upon reaching the limiting temperature, the closure 6 is opened by the actuating device 7, as shown in FIG. 1(b). The hot air from the interior of the heat shield may escape through the opening 5. The suction thus arising causes cooler air to flow behind through the space between heat shield 1 and neighboring component 10, so that an optimal operating temperature of the catalytic converter 2 is ensured in spite of the heat radiated by the component 10. The space between heat shield 1 and neighboring component 10 may be tailored—insofar as this is possible in the existing space—to this operating temperature of the catalytic converter 2 and the radiation of the component 10.

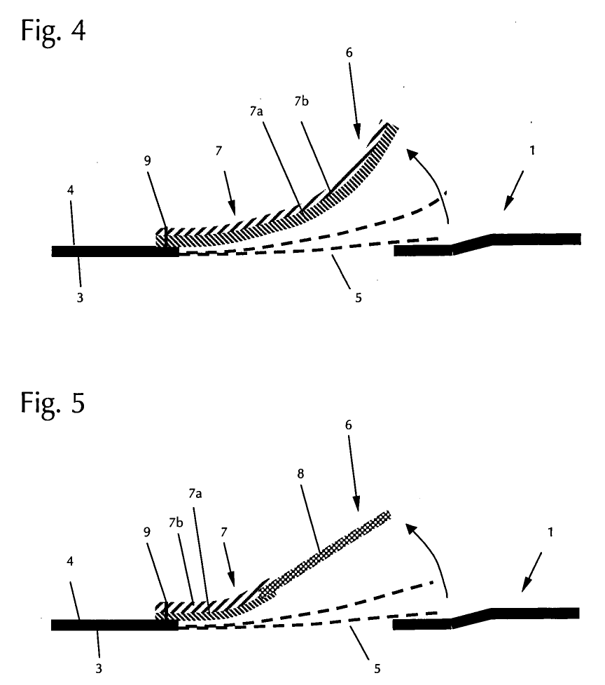

FIGS. 4 and 5 show two possible embodiments of a closure opening and closing automatically as a function of the temperature. In FIG. 4, the closure 6 completely comprises a bimetallic element 7, while the closure 6 in FIG. 5 is only partially formed by a bimetallic element 7 and the remaining part 8 of the closure 6 comprises a material which is not a bimetal.

The closures 6 illustrated in the preceding figures essentially correspond to the closure illustrated in detail in FIG. 4. This closure completely comprises a bimetallic element 7 having a layer 7a facing toward the surface 4 of the heat shield 1 and a layer 7b situated thereon. The layer 7a comprises a metal having a higher thermal expansion coefficient than the thermal expansion coefficient of the metal layer 7b. If the temperature on the side of the internal surface 3 of the heat shield 1 (i.e., toward the interior of the heat shield 1) exceeds a predefined limiting temperature, the metal of the layer 7a expands more strongly than the metal of the layer 7b, by which the layer 7a arches outward in the direction away from the surface 4 of the heat shield 1.

The bimetallic element 7 forming the closure 6 is fastened at one end (the left here) to the heat shield. The fastening point is identified by 9 and may comprise a spot weld, a weld seam, or a rivet, for example. Arbitrary other suitable fastening possibilities are also conceivable. Under the influence of the elevated temperature in the interior of the heat shield 1, the bimetallic element 7 thus arches outward, so that the free end of the closure 6 opposite the fastening point 9 is lifted up from the surface 4 of the heat shield 1. The higher the temperature in the interior of the heat shield 1, the stronger the bending of the closure 6. This is indicated by the dashed lines and the arrow, which shows the direction of the arching. The lowermost dashed line illustrates the position of the closure in the closed state, i.e., at a temperature below the limiting temperature. The second dashed line above the closed position indicates a position in which the temperature is somewhat above the limiting temperature, at which the deformation of the bimetallic element 7 begins. The illustrated position of the closure 6 corresponds to the maximum opening position of the closure to be expected under the existing temperature conditions.

FIG. 5 shows an alternative embodiment of the closure 6. The bimetallic element 7 only forms a part of the closure 6 here, namely the area at which the closure is fastened to the heat shield 1. The free end of the closure 6, in contrast, comprises a section 8 which does not comprise bimetallic material. The left end of the section 8 in FIG. 5 is fastened between the layers 7a and 7b of the bimetallic element 7. The automatic opening and closing of the closure 6 occurs fundamentally in the same way as was described for FIG. 3. The layer 7a also comprises a metal having a greater thermal expansion coefficient than that of the layer 7b. At a temperature above a predefined limiting temperature in the interior of the heat shield 1, the bimetallic element therefore arches outward away from the heat shield 1, so that the through opening 5 is increasingly exposed by the closure 6 with rising temperature. Vice versa, the closure 6 closes the through opening 5 increasingly when the temperature sinks again in the interior of the heat shield 1.

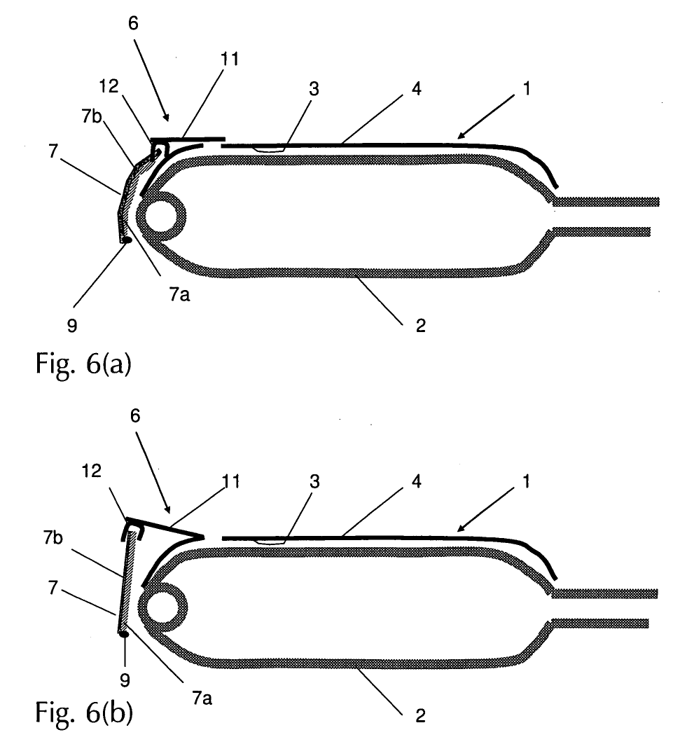

A fourth exemplary embodiment of the heat shield 1 and a catalytic converter 2 to be shielded are shown in cross-section in FIG. 6(a). The closure 6 is made of a plate 11 and a bimetallic element 7, the bimetallic element being fastened using rivets, welds, or screws to a point 10 in proximity to the heat shield. The bimetallic element 7 is at least partially guided in a rail 12 on the plate 11. The end facing toward the rail 12 may be hooked in the rail 12, for example. The bimetallic element 7 overlaps with the heat shield 1 and extends it. The projecting part of the bimetallic element 7 is thus subjected on its internal surface to the same conditions as the internal surface 3 of the heat shield 1. In contrast to the exemplary embodiments shown up to this point, the bimetallic element is curved in the cooled state. After the engine is started, the layer 7a of the bimetallic element 7 made of a metal having a greater thermal expansion coefficient, which faces toward the catalytic converter, expands more strongly due to the heating than the layer 7b, which has the lower thermal expansion coefficient. As shown in FIG. 6(b), the bimetallic element is straightened upon heating above the limiting temperature and exposes the opening 5 via a pull mechanism. This closure also allows reproducible closing upon cooling of the internal surface 3 of the heat shield 1 and/or the bimetallic element 7.

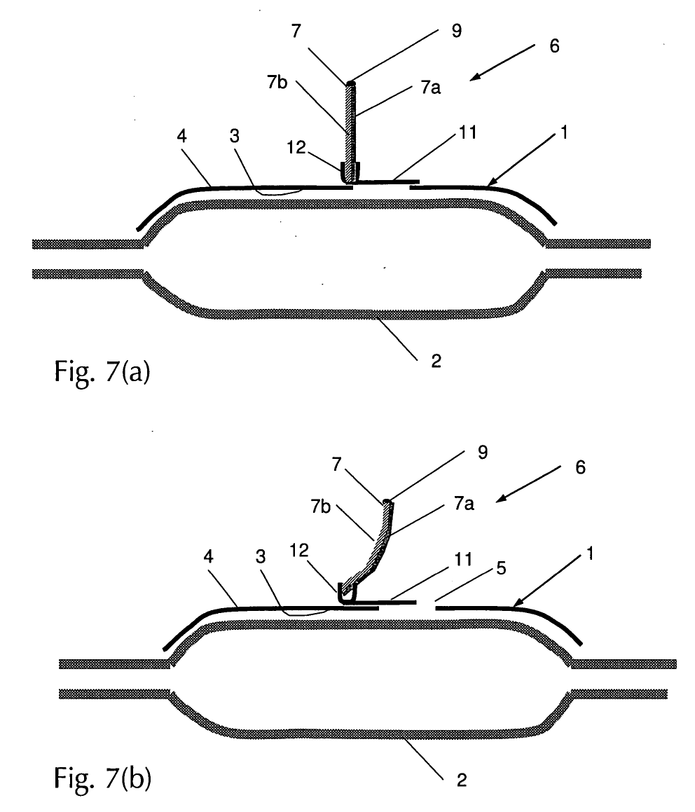

FIG. 7(a) shows a further embodiment of the heat shield 1 according to the present invention and a catalytic converter 2 in cross-section. The bimetallic element 7 is not a part of the internal surface of the heat shield here, but rather the heat transfer to the bimetallic element 7 occurs via the plate 11. In this embodiment, the bimetallic element 7 also guides the plate in such a way that it at least partially exposes the opening 5 in the event of temperature increase above the limiting temperature, as shown in FIG. 7(b). If the temperature drops below the limiting temperature, the closure 6 closes again, the plate 11 is pulled onto the opening 5. Contrary to the exemplary embodiment previously shown in FIGS. 6(a) and 6(b), the opening is performed using a thrust mechanism. The part 7a of the bimetallic element 7 having greater thermal expansion is correspondingly attached on the side of the opening 5 and/or the plate 11.

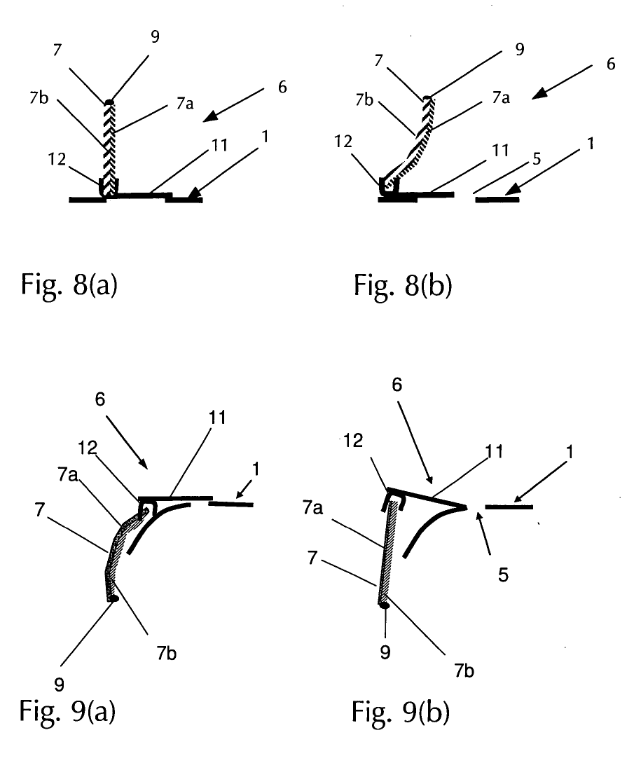

FIGS. 8(a) through 10(c) illustrate detail views of possible embodiments of a slide of the heat shield according to the present invention, each having closed and open closure. FIGS. 8(a) and 8(b) correspond to the thrust mechanism shown in FIGS. 7(a) and 7(b). FIGS. 9(a) and 9(b) illustrate the pull mechanism from FIGS. 6(a) and 6(b).

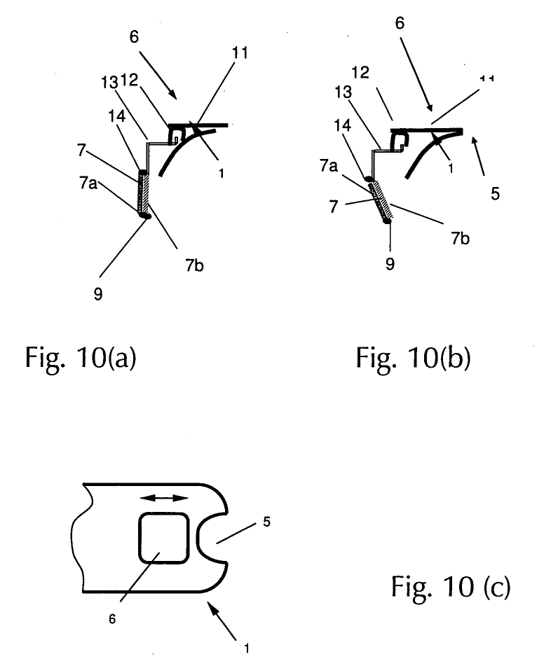

FIGS. 10(a) through 10(c) show an embodiment in which the opening 5 in the heat shield 1 is a recess in the external edge area of the heat shield. FIG. 10(c) illustrates this very schematically in a top view of a top side of the heat shield 1. The opening is closable using a slide 11 as a closure 6. The closure 6 may be displaced in the direction of the arrow using a closing mechanism, which is a variant of the pull mechanism from FIGS. 9(a) and 9(b). Only part of the actuator is formed by the bimetallic element 7, which is fastened via an angled bar 13 to the guide 12 of the plate 11. The bar 13 is connected using rivets, welds, screws, etc., at the end 14 to the bimetallic element 7. The actuator is thus formed by the bimetallic element 7 including its fastener 9, bar 13, and guide 12. In addition to the angled embodiment of the bar 13 shown here, curved, sickle-shaped, and other variants are also usable in principle.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A heat shield for shielding an object from heat and/or noise having an internal surface facing toward the object and an external surface facing away from the object, as well as an opening, which goes through the heat shield having internal surface and external surface,
comprising a closure for at least partially closing the opening, which opens and closes automatically as a function of the temperature.

2. The heat shield according to claim 1, wherein the closure is implemented to open or close as a function of the temperature on the side of the internal surface.

3. The heat shield according to claim 1, wherein the closure is implemented to open upon exceeding a specific limiting temperature and to close at a temperature less than or equal to the limiting temperature.

4. The heat shield according to claim 3, wherein the closure is implemented to expose the opening increasingly with increasing difference from the limiting temperature.

5. The heat shield according to claim 1, wherein the closure is implemented to open toward the side of the external surface.

6. The heat shield according to claim 1, wherein the closure is implemented to close upon exceeding a specific limiting temperature and to open at a temperature less than or equal to the limiting temperature.

7. The heat shield according to claim 6, wherein the closure is implemented to close the opening increasingly with increasing difference from the limiting temperature.

8. The heat shield according to claim 1, wherein the closure at least partially comprises a bimetallic element.

9. The heat shield according to claim 8, wherein the closure is formed on its free end by a section not comprising bimetal, which is retained by the bimetallic element.

10. The heat shield according to claim 1, wherein at least one further closure, which opens and closes automatically as a function of the temperature, is provided for at least partially closing a further opening.

11. The heat shield according to claim 10, wherein the further closure is implemented to open upon exceeding another temperature than the first closure.

12. The heat shield according to claim 11, wherein the further closure is implemented to open at a higher limiting temperature than the first closure.

13. The heat shield according to claim 1, wherein the closure is implemented in the form of a flap.

14. The heat shield according to claim 3, wherein the side of the bimetallic element facing toward the internal surface comprises a material having a higher thermal expansion coefficient and the side facing toward the external surface comprises a material having a lower thermal expansion coefficient.

15. The heat shield according to claim 6, wherein the side of the bimetallic element facing toward the internal surface comprises a material having a lower thermal expansion coefficient and the side facing toward the external surface comprises a material having a higher thermal expansion coefficient.

16. The heat shield according to claim 1, wherein the closure contains a slide.

17. The heat shield according to claim 15, wherein the closure is opened using a pull mechanism.

18. The heat shield according to claim 13, wherein the closure is opened using a thrust mechanism.

19. The heat shield according to claim 1, wherein the heat shield encloses the object to be shielded essentially on all sides.

20. The heat shield according to claim 1, wherein the heat shield shields an object in the area of an internal combustion engine.

21. The heat shield according to claim 19, wherein the heat shield encloses one of a catalytic converter, a diesel particulate filter, turbocharger, and an exhaust system.
